(19) United States
(12) Patent Application Publication
(10) Pub. No.: US 2022/0260008 A1
(43) Pub. Date: Aug. 18, 2022

(54) SUPERCHARGING SYSTEM

(71) Applicant: SUBARU CORPORATION, Tokyo (JP)

(72) Inventor: Hiroki MORIKA, Tokyo (JP)

(21) Appl. No.: 17/583,836

(22) Filed: Jan. 25, 2022

(30) Foreign Application Priority Data
Feb. 12, 2021 (JP) 2021-021182

(51) Int. Cl. F02B 39/10; F01N 5/04; F03D 9/28; H02J 7/14

(52) U.S. Cl. CPC F02B 39/10; F01N 5/04; F03D 9/28; H02J 2207/50; F05B 2220/70; H02J 2207/20; H02J 7/14

(57) ABSTRACT

A supercharging system to be mounted in a vehicle including an engine serving as an internal combustion engine, and a chargeable and dischargeable electric power storage unit includes an exhaust turbine, an electrically powered intake compressor, and an electric power converter. The exhaust turbine is configured to generate electric power in response to receipt of exhaust from the engine. The intake compressor is configured to feed compressed intake air to the engine. The electric power converter is configured to accumulate the electric power generated by the exhaust turbine in the electric power storage unit and supply the electric power accumulated in the electric power storage unit to the intake compressor. At least one of the exhaust turbine or the intake compressor is of an axial-flow type.

### CROSS-REFERENCE TO RELATED APPLICATIONS

The present application claims priority from Japanese Patent Application No. 2021-021182 filed on Feb. 12, 2021, the entire contents of which are hereby incorporated by reference.

### BACKGROUND

The disclosure relates to a supercharging system for feeding compressed air to an engine.

In an existing mechanical supercharger, an intake compressor is driven by utilizing the rotational power of an exhaust turbine to feed compressed air from the intake compressor to an engine. Japanese Unexamined Patent Application Publication (JP-A) No. H09-32569 proposes a supercharger in which electric power is generated by utilizing the rotational power of an exhaust turbine to drive an intake compressor with the generated electric power.

### SUMMARY

An aspect of the disclosure provides a supercharging system to be mounted in a vehicle. The vehicle includes an engine serving as an internal combustion engine, and a chargeable and dischargeable electric power storage unit. The supercharging system includes an exhaust turbine, an electrically powered intake compressor, and an electric power converter. The exhaust turbine is configured to generate electric power in response to receipt of exhaust from the engine. The intake compressor is configured to feed compressed intake air to the engine. The electric power converter is configured to accumulate the electric power generated by the exhaust turbine in the electric power storage unit and supply the electric power accumulated in the electric power storage unit to the intake compressor. At least one of the exhaust turbine or the intake compressor is of an axial-flow type.

An aspect of the disclosure provides a supercharging system to be mounted in a vehicle. The vehicle includes an engine serving as an internal combustion engine, and a chargeable and dischargeable electric power storage unit. The supercharging system includes an exhaust turbine, an electrically powered intake compressor, and an electric power converter. The exhaust turbine is configured to generate electric power in response to receipt of exhaust from the engine. The intake compressor is configured to feed compressed intake air to the engine. The electric power converter is configured to accumulate the electric power generated by the exhaust turbine in the electric power storage unit and supply the electric power accumulated in the electric power storage unit to the intake compressor. A rotary shaft of the exhaust turbine and a rotary shaft of the intake compressor are non-parallel to each other.

### BRIEF DESCRIPTION OF THE DRAWINGS

The accompanying drawings are included to provide a further understanding of the disclosure and are incorporated in and constitute a part of this specification. The drawings illustrate example embodiments and, together with the specification, serve to explain the principles of the disclosure.

FIG. 1 is a block diagram illustrating a vehicle including a supercharging system according to an embodiment of the disclosure;

FIGS. 2A and 2B are diagrams illustrating an example of supercharging pressure map data and compression power map data stored in a control data memory, respectively;

FIGS. 3A and 3B are diagrams illustrating an example of first correction table data and second correction table data stored in the control data memory, respectively;

FIG. 4 is a flowchart illustrating a supercharging control process executed by a controller;

FIGS. 5A and 5B are diagrams illustrating a first example and a second example of an exhaust turbine, an intake compressor, an electric power converter, and electric power lines among them, respectively; and

FIGS. 6A and 6B are diagrams illustrating a first modification and a second modification of the exhaust turbine and the intake compressor, respectively.

### DETAILED DESCRIPTION

In the existing supercharger, the rotary shaft of the exhaust turbine, which is of a centrifugal type, and the rotary shaft of the intake compressor, which is of the centrifugal type, are coaxial or parallel to each other. There are accordingly constraints on the layout of an exhaust pipe and an intake pipe of the engine.

It is desirable to provide a supercharging system with high flexibility in the layout of an exhaust pipe and an intake pipe.

In the following, some embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same numerals to avoid any redundant description.

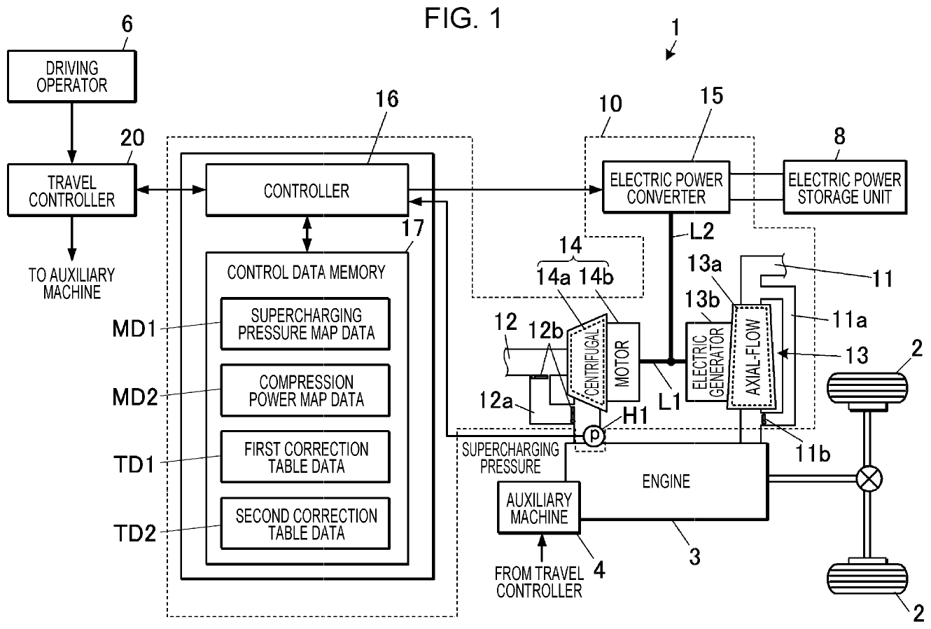

FIG. 1 is a block diagram illustrating a vehicle 1 including a supercharging system 10 according to an embodiment of the disclosure. The vehicle 1 illustrated in FIG. 1 is an engine vehicle including the supercharging system 10 according to the embodiment of the disclosure. The vehicle 1 includes drive wheels 2, an engine 3, an auxiliary machine 4, the supercharging system 10, a driving operator 6, a travel controller 20, and an electric power storage unit 8. The engine 3 serves as an internal combustion engine. The auxiliary machine 4 is used to activate the engine 3, and examples of the auxiliary machine 4 include a fuel injection device. The supercharging system 10 is an auxiliary machine of an intake and exhaust system. The driving operator 6 is operated by the driver. The travel controller 20 controls the auxiliary machine 4 and the supercharging system 10 in response to an operation signal from the driving operator 6. The electric power storage unit 8 is configured to be charged and discharged upon being coupled to the supercharging system 10. The driving operator 6 includes an accelerator operator, a brake operator, and a steering operator.

The travel controller 20 is constituted by one electronic control unit (ECU) or a plurality of ECUs that operate in cooperation with each other. In response to receipt of an operation signal from the driving operator 6 (mainly, a signal of the accelerator opening degree from the accelerator operator), the travel controller 20 controls the auxiliary machine 4 and the supercharging system 10 to drive the engine 3 in accordance with the driving operation. In one example, the travel controller 20 calculates the requested torque corresponding to the driving operation, based on the signal of the accelerator opening degree, and controls the auxiliary machine 4 and the supercharging system 10 to output the requested torque from the engine 3. The requested torque refers to an output torque to be requested for the engine 3 in accordance with the driving operation.

The supercharging system 10 includes an exhaust pipe 11 of the engine 3, an intake pipe 12 of the engine 3, an exhaust turbine 13 disposed for the exhaust pipe 11, an intake compressor 14 disposed for the intake pipe 12, an electric power line L1 disposed between the exhaust turbine 13 and the intake compressor 14, an electric power converter 15, a controller 16, and a pressure gauge H1. The electric power converter 15 is configured to supply a portion of electric power from the electric power storage unit 8 or recover a portion of electric power to the electric power storage unit 8 via the electric power line L1 and a branch line L2. The controller 16 controls the electric power converter 15. The pressure gauge H1 measures the supercharging pressure of intake air. The pressure gauge H1 is located closer to the engine 3 than a throttle valve of the intake pipe 12 and is configured to measure the pressure of intake air in this location.

The exhaust turbine 13 is disposed in the middle of the exhaust pipe 11 through which the exhaust of the engine 3 flows. The exhaust pipe 11 may include a bypass pipe 11a through which the exhaust flows while bypassing the exhaust turbine 13, and a control valve 11b configured to control the flow of the exhaust to the bypass pipe 11a. Switching of the control valve 11b may be controlled by the controller 16.

The intake compressor 14 is disposed in the middle of the intake pipe 12 through which the intake air of the engine 3 flows. The intake pipe 12 may include a bypass pipe 12a through which the intake air flows while bypassing the intake compressor 14, and control valves 12b configured to control the flow of the intake air to the bypass pipe 12a. Switching of the control valves 12b may be controlled by the controller 16.

The exhaust turbine 13 includes a rotor 13a rotatable in response to exhaust, and an electric generator 13b configured to generate electric power in response to the rotational motion of the rotor 13a. The exhaust turbine 13 is an axial-flow turbine including the rotor 13a having a rotary shaft along the flow of the exhaust. When used as an axial-flow turbine, the exhaust turbine 13 is configured such that the input pipe and the output pipe are easily disposed coaxially with each other. The axial-flow configuration of the exhaust turbine 13, which can be operated with high efficiency at a high exhaust flow velocity, provides high electric power recovery efficiency when the engine 3 is a high-rotation engine. The exhaust turbine 13 outputs the generated electric power to the electric power line L1.

The intake compressor 14 is a centrifugal compressor including a rotor 14a configured to compress intake air, and an electric motor 14b configured to rotationally drive the rotor 14a, such that intake air is sucked in the axial direction of the rotor 14a and compressed air is output to the outside in the radial direction of the rotor 14a. When used as a centrifugal compressor, the intake compressor 14 is configured such that the input pipe and the output pipe easily intersect each other. In one example, the input pipe and the output pipe are perpendicular to each other. The intake compressor 14 is driven in response to receipt of electric power from the electric power line L1.

The rotary shaft of the exhaust turbine 13 (i.e., the rotary shaft of the rotor 13a) and the rotary shaft of the intake compressor 14 (i.e., the rotary shaft of the rotor 14a) are non-parallel to each other.

The electric power line L1 has an end coupled to the electric generator 13b of the exhaust turbine 13, and another end coupled to the electric motor 14b of the intake compressor 14. The electric power line L1 may include, between the exhaust turbine 13 and the intake compressor 14, a relay or the like that is turned on whenever the supercharging system 10 is in operation, or a rectifier element for preventing current from flowing back toward the electric generator 13b.

The electric power converter 15 is disposed in the branch line L2 coupled to the electric power line L1. The electric power converter 15 is disposed between the electric power line L1 and the electric power storage unit 8 and is configured to recover electric power from the electric power line L1 to the electric power storage unit 8 and supply electric power from the electric power storage unit 8 to the electric power line L1. The electric power converter 15 includes a power semiconductor switch. The power semiconductor switch is driven to control the flow of electric power.

The controller 16 receives information indicating the operation of the driving operator 6 (e.g., the requested torque) and information indicating the operating state of the engine 3 (e.g., the rotational speed of the engine 3) from the travel controller 20. The controller 16 also receives information on the supercharging pressure from the pressure gauge H1. The controller 16 controls the electric power converter 15 based on the received information. The controller 16 is constituted by one ECU or a plurality of ECUs that operate in cooperation with each other. The controller 16 may be integrated with the travel controller 20.

The controller 16 includes a control data memory 17 that stores control data for controlling the electric power converter 15. The control data memory 17 stores supercharging pressure map data MD1, compression power map data MD2, first correction table data TD1, and second correction table data TD2. In an embodiment of the disclosure, the supercharging pressure map data MD1 corresponds to an example of first map data. In an embodiment of the disclosure, the compression power map data MD2 corresponds to an example of second map data.

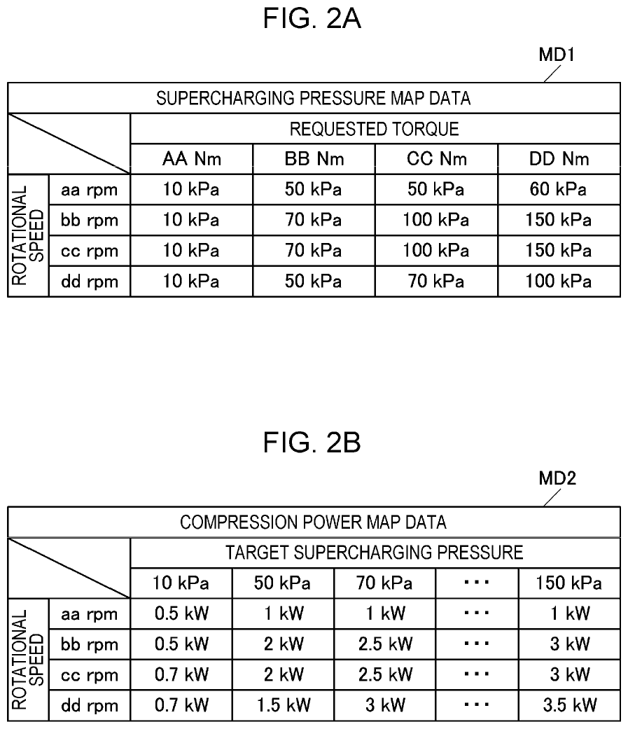

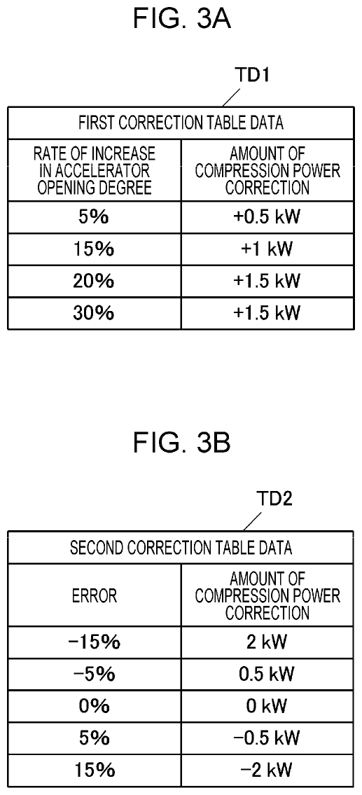

FIGS. 2A and 2B are diagrams illustrating an example of the supercharging pressure map data MD1 and the compression power map data MD2 stored in the control data memory 17, respectively. FIGS. 3A and 3B are diagrams illustrating an example of the first correction table data TD1 and the second correction table data TD2 stored in the control data memory 17, respectively.

The supercharging pressure map data MD1 indicates a relationship among the operating state (e.g., the rotational speed) of the engine 3, a quantity related to the operation of the driving operator 6 (e.g., a requested torque), and a supercharging pressure of intake air corresponding to the operating state and the quantity. The compression power map data MD2 indicates a relationship among the operating state (e.g., the rotational speed) of the engine 3, a supercharging pressure of intake air, and the compression power (e.g., the operating power) of the intake compressor 14 to be used to output the supercharging pressure in the operating state.

The first correction table data TD1 indicates a relationship between a specific operation (e.g., a rapid accelerator operation) of the driving operator 6 and a correction value of the compression power described above corresponding to the specific operation. The rapid accelerator operation is an accelerator operation in which the rate of increase in the amount of operation of the accelerator pedal per predetermined time interval is greater than or equal to a preset threshold, and a plurality of stages of specific operations are set in accordance with the rate of increase. The second correction table data TD2 indicates a correction value for reducing an error between a target supercharging pressure and an actual supercharging pressure. The first correction table data TD1 and the second correction table data TD2 indicate correction values of the compression power (i.e., the operating power).

### Operation

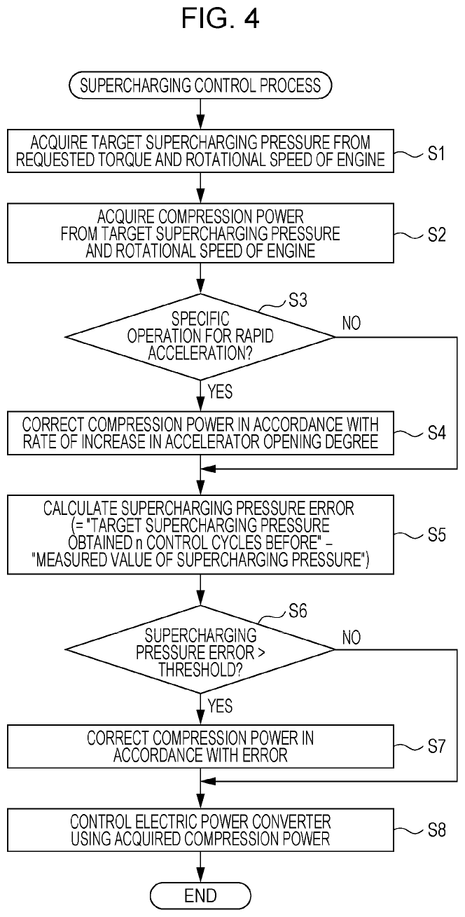

FIG. 4 is a flowchart illustrating a supercharging control process executed by the controller 16. During the driving of the engine 3, the controller 16 repeatedly executes the supercharging control process illustrated in FIG. 4 for each predetermined control cycle. Upon start of a control cycle, first, the controller 16 refers to the supercharging pressure map data MD1 and acquires, from information related to the operation of the driving operator 6 (e.g., a requested torque) and the operating state (e.g., the rotational speed) of the engine 3, a target value of the supercharging pressure of intake air (hereinafter referred to as “target supercharging pressure”) corresponding to the operation of the driving operator 6 and the operating state of the engine 3 described above (step S1).

Then, the controller 16 refers to the compression power map data MD2 and acquires the compression power of the intake compressor 14 (e.g., the operating power of the intake compressor 14) to be used to output the target supercharging pressure in the operating state of the engine 3 in the current control cycle (step S2). The value of the compression power acquired in step S2 corresponds to a target value of the compression power to be output from the intake compressor 14 under the control of the controller 16.

Then, the controller 16 determines whether a specific operation requesting rapid acceleration (e.g., a rapid accelerator operation) is performed (step S3). The travel controller 20 notifies the controller 16 if the specific operation is performed. If the determination result of step S3 is YES, the controller 16 refers to the first correction table data TD1 to determine an amount of correction of the compression power (e.g., the operating power of the intake compressor 14) corresponding to the amount of the specific operation, and applies the amount of correction to the compression power (step S4).

Then, the controller 16 compares a target supercharging pressure obtained n control cycles before the current control cycle (e.g., the immediately preceding control cycle or a plurality of control cycles before the current control cycle) with a supercharging pressure measured with the pressure gauge H1 at the timing when intake air is output under control in the control cycle, and calculates a supercharging pressure error (step S5). Then, the controller 16 determines whether the supercharging pressure error exceeds a threshold (e.g., ±5%) (step S6). If the determination result is YES, the controller 16 refers to the second correction table data TD2 to determine an amount of correction of the compression power (e.g., the operating power of the intake compressor 14) corresponding to the error, and applies the amount of correction to the compression power (step S7).

Then, the controller 16 controls the electric power converter 15 such that the intake compressor 14 operates with the finally obtained compression power of the intake compressor (step S8). Through the control described above, the difference between the operating power of the intake compressor 14 and the electric power generated by the exhaust turbine 13 is supplied from the electric power storage unit 8 or recovered to the electric power storage unit 8 through the electric power converter 15. Through the control in step S8, the intake compressor 14 is supplied with electric power corresponding to the compression power, and the compression power is output from the intake compressor 14. Then, the supercharging control process in the current control cycle ends. In the next control cycle, the controller 16 again executes the supercharging control process in step S1.

### Specific Example of Electrical Configuration of Supercharging System

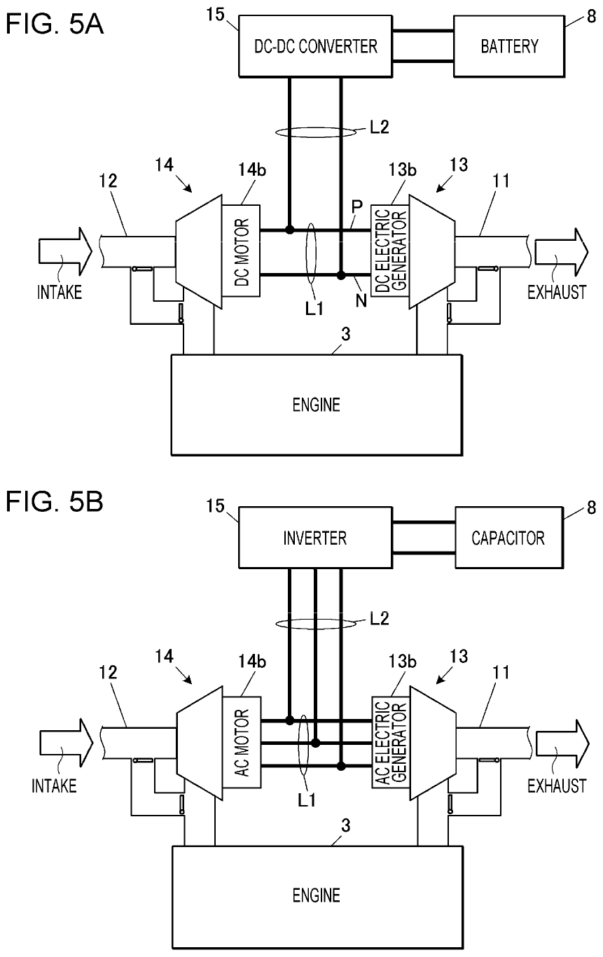

FIGS. 5A and 5B are diagrams illustrating a first example and a second example indicating the exhaust turbine 13, the intake compressor 14, the electric power converter 15, and electric power lines among them. In FIGS. 5A and 5B, the exhaust turbine 13 is a centrifugal turbine, for example. The exhaust turbine 13 may be an axial-flow turbine. Also, the intake compressor 14 may be an axial-flow compressor.

In the first example illustrated in FIG. 5A, the electric generator 13b of the exhaust turbine 13 is a direct-current (DC) electric generator configured to generate DC electric power, and the electric motor 14b of the intake compressor 14 is a DC motor that is driven in response to the DC electric power. In this configuration, the electric power line L1 and the branch line L2 may be DC two-wire electric power lines each having an anode line P and a cathode line N. The electric power converter 15 may be a DC/DC converter configured to convert a DC voltage of the electric power storage unit 8 into a DC voltage of the electric power line L1. The electric power storage unit 8 may be a battery (such as a lithium ion secondary battery or a lead battery) or a capacitor (such as an electric double layer capacitor). In the example illustrated in FIG. 5A, the electric power storage unit 8 is a battery.

In the configuration in the first example, the controller 16 controls the output voltage of the electric power converter 15 (i.e., the voltage of the electric power line L1) to a value corresponding to the intended compression power of the intake compressor 14 to appropriately supply electric power from the electric power storage unit 8 or recover electric power to the electric power storage unit 8 in accordance with the electric power generated by the exhaust turbine 13. As a result, the intake compressor 14 can be driven with the target compression power (e.g., the operating power).

In one example, in the configuration in the first example, when the rotational speed of the engine 3 is constant, as the voltage of the electric power line L1 increases, the rotational speed of the intake compressor 14 increases, resulting in an increase in the operating power and compression power of the intake compressor 14. Accordingly, the supercharging pressure of the intake air increases. In contrast, as the voltage of the electric power line L1 decreases, the rotational speed of the intake compressor 14 decreases, resulting in a decrease in the operating power and compression power of the intake compressor 14. Accordingly, the supercharging pressure of the intake air decreases. If the rotational speed of the exhaust turbine 13 is low and the generated electric power from the exhaust turbine 13 is small, the effect of increasing the voltage of the electric power line L1 in response to the supply of the generated electric power is reduced, and the electric power to be fed from the electric power storage unit 8 to the electric power line L1 in accordance with the control of the output voltage of the electric power converter 15 is increased accordingly. In contrast, if the rotational speed of the exhaust turbine 13 is high and the electric power generated by the exhaust turbine 13 is large, the effect of increasing the voltage of the electric power line L1 in response to the supply of the generated electric power is increased, and the electric power to be fed from the electric power storage unit 8 to the electric power line L1 in accordance with the control of the output voltage of the electric power converter 15 is reduced accordingly. Alternatively, if the electric power generated by the exhaust turbine 13 is further large, electric power is recovered from the electric power line L1 to the electric power storage unit 8 in accordance with the control of the output voltage of the electric power converter 15. With the effect described above, the difference between the electric power generated by the exhaust turbine 13 and the compression power (i.e., the operating power) of the intake compressor 14 is supplied from the electric power storage unit 8 or recovered to the electric power storage unit 8, and the intake compressor 14 can be driven with the target compression power.

In the second example illustrated in FIG. 5B, the electric generator 13b of the exhaust turbine 13 is a three-phase alternating-current (AC) electric generator, and the electric motor 14b of the intake compressor 14 is a three-phase AC electric motor. In this configuration, the electric power line L1 and the branch line L2 may be three-phase three-wire electric power lines. The electric power converter 15 may be an inverter capable of converting a DC voltage of the electric power storage unit 8 into a three-phase AC voltage. The electric power storage unit 8 may be a battery (such as a lithium ion secondary battery or a lead battery) or a capacitor (such as an electric double layer capacitor). In the example illustrated in FIG. 5B, the electric power storage unit 8 is a capacitor.

In the configuration in the second example, the controller 16 controls the output voltage of the electric power converter 15 (i.e., the three-phase AC voltage output to the electric power line L1) to an AC voltage corresponding to a target value of the compression power to appropriately supply electric power from the electric power storage unit 8 or recover electric power to the electric power storage unit 8 in accordance with the electric power generated by the exhaust turbine 13. As a result, the intake compressor 14 can be driven with the target compression power (e.g., the operating power).

In one example, in the configuration in the second example, the electric power converter 15 outputs an AC voltage for driving by the intake compressor 14 at a predetermined torque and a predetermined rotational speed. As a result, the intake compressor 14 is driven with the compression power corresponding to the predetermined torque and the predetermined rotational speed (e.g., the operating power). Accordingly, a supercharging pressure corresponding to the compression power is obtained. At this time, the electric power generated by the exhaust turbine 13 is fed to the electric power line L1. In accordance with the control of the AC voltage of the electric power converter 15, the electric power converter 15 operates such that the difference between the electric power generated by the exhaust turbine 13 and the operating power of the intake compressor 14 is supplied from the electric power storage unit 8 or recovered to the electric power storage unit 8.

When the electric generator 13b of the exhaust turbine 13 is three-phase AC electric generator and the electric motor 14b of the intake compressor 14 is a three-phase AC electric motor, the following configuration may be used: The electric power line L1 and the branch line L2 are DC two-wire lines, the intake compressor 14 is coupled to the electric power line L1 via a first inverter, the exhaust turbine 13 is coupled to the electric power line L1 via a second inverter, and the branch line L2 is coupled to the electric power storage unit 8. In this configuration, the controller 16 controls the first inverter to drive the intake compressor 14 with the target compression power (e.g., the operating power), and controls the second inverter to recover electric power with high efficiency in accordance with the rotational speed of the exhaust turbine 13. Even this configuration can implement an operation in which the difference between the electric power generated by the exhaust turbine 13 and the compression power (i.e., the operating power) of the intake compressor 14 is supplied from the electric power storage unit 8 or recovered to the electric power storage unit 8 via the first inverter and the second inverter. A rectifier element such as a power diode may be disposed between the first inverter and the second inverter to prevent electric power from being fed to the exhaust turbine 13.

In the configurations illustrated in FIGS. 5A and 5B, the controller 16 is configured such that the electric power generated by the exhaust turbine 13 is not measured and the excess or deficiency of the electric power is supplied from the electric power storage unit 8 or recovered to the electric power storage unit 8 via the electric power converter 15 to drive the intake compressor 14 with the target compression power. Alternatively, the supercharging system 10 may include a measurement device configured to measure a quantity related to the amount of electric power generated by the exhaust turbine 13 (such as the rotational speed of the rotor 13a), and the controller 16 may recognize the generated electric power by using the value of the measurement device and calculate the excess or deficiency of the electric power to control the electric power converter 15 to supply or recover electric power corresponding to the excess or deficiency.

### Modifications of Intake Compressor and Exhaust Turbine

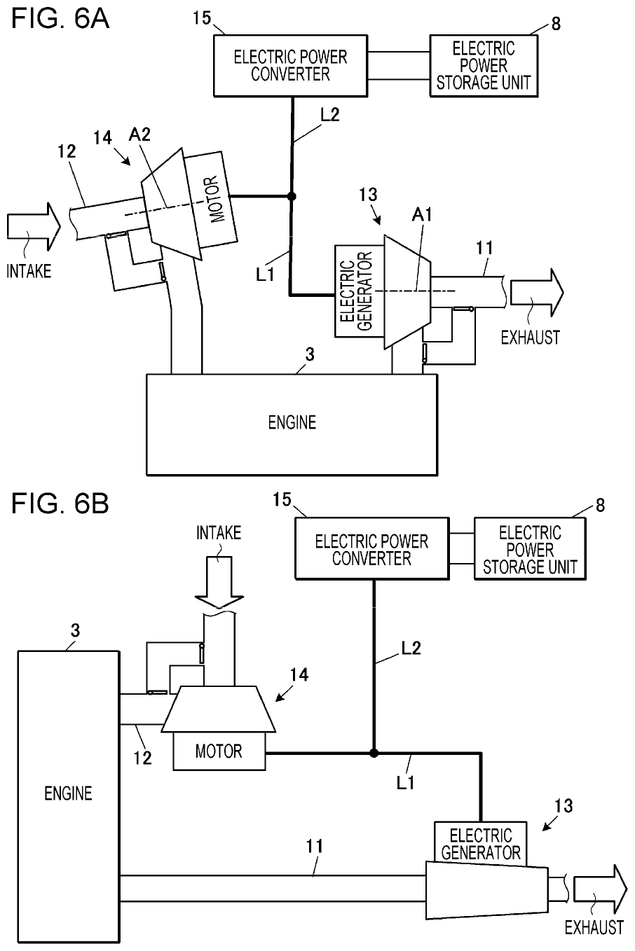

FIGS. 6A and 6B are diagrams illustrating a first modification and a second modification of the intake compressor 14 and the exhaust turbine 13, respectively. In the supercharging system 10 according to this embodiment, kinetic energy recovered by the exhaust turbine 13 is converted into electric power, and the electric power is fed to the intake compressor 14. In the supercharging system 10, therefore, the exhaust turbine 13 and the intake compressor 14 are disposed more flexibly than those in a mechanical supercharger in which kinetic energy is fed from the exhaust turbine directly to the intake compressor. The supercharging system 10 having such flexibility may provide configurations according to the first modification and the second modification.

In the first modification, as illustrated in FIG. 6A, the exhaust turbine 13 and the intake compressor 14 are of the centrifugal type, and are disposed such that a rotary shaft A1 of a rotor of the exhaust turbine 13 and a rotary shaft A2 of a rotor of the intake compressor 14 are not aligned coaxially but are non-parallel to each other.

In the second modification, as illustrated in FIG. 6B, the exhaust pipe 11 and the intake pipe 12 are spaced apart from each other, and the exhaust turbine 13 and the intake compressor are disposed apart from each other. In the second modification, furthermore, the rotary shaft of the exhaust turbine 13 and the rotary shaft of the intake compressor 14 are not aligned coaxially but are non-parallel to each other.

The type and layout of the exhaust turbine 13 and the intake compressor 14 are not limited to those in the examples illustrated in FIGS. 1, 6A, and 6B, and may be changed in various ways. The intake compressor 14 may be of an axial-flow type, and the exhaust turbine 13 may be of the centrifugal type. Alternatively, both the exhaust turbine 13 and the intake compressor 14 may be of the axial-flow type. Further, the rotary shaft A1 of the exhaust turbine 13 and the rotary shaft A2 of the intake compressor 14 may be disposed to face in any direction in accordance with the exhaust pipe 11 and the intake pipe 12.

When an exhaust turbine of the axial-flow type or an intake compressor of the axial-flow type are used, a high-efficiency operation is implemented at a high flow velocity of the exhaust or intake air. Thus, a supercharging system when adopted in a high-rotation engine provides high efficiency. When an exhaust turbine of the centrifugal type or an intake compressor of the centrifugal type is used, a high-efficiency operation is implemented at a low flow velocity of the exhaust or intake air. Thus, a supercharging system when adopted in a low-rotation engine provides high efficiency. As described above, the types of the exhaust turbine 13 and the intake compressor 14 are selected to support engines having various characteristics, improving supercharging efficiency.

Since the exhaust turbine 13 and the intake compressor 14 can be disposed flexibly in accordance with the installation space for the components when the vehicle 1 is designed, the supercharging system can be easily installed even if the installation space is limited.

Advantages of the supercharging system 10 according to this embodiment will be described hereinafter. A typical mechanical supercharger or an electrically powered supercharger having a similar layout of components to those of the mechanical supercharger has a constraint that an exhaust path or an intake path bends in a perpendicular direction, and further has a constraint that the exhaust pipe and the intake pipe are concentrated in (e.g., in close proximity to) a portion of the supercharger. In the supercharging system 10 according to this embodiment, in contrast, the axial-flow configuration of the exhaust turbine 13 removes the constraint on the exhaust path for the centrifugal type, and the exhaust path can be a path having a few curves, such as a straight-line path. In the supercharging system 10 according to this embodiment, furthermore, since electric power is fed from the exhaust turbine 13 to operate the intake compressor 14, the exhaust pipe coupled to the exhaust turbine 13 and the intake pipe coupled to the intake compressor 14 can be spaced apart from each other. Therefore, the flexibility in the layout of the exhaust pipe and the intake pipe coupled to the supercharging system 10 can be improved.

In the embodiment illustrated in FIG. 1, the exhaust turbine 13 is of the axial-flow type. Alternatively, both the exhaust turbine 13 and the intake compressor 14 may be of the axial-flow type, or the exhaust turbine 13 may be of the centrifugal type and the intake compressor 14 may be of the axial-flow type. Even in this configuration, the axial-flow type improves the flexibility in the layout of the exhaust pipe or the intake pipe for the same reason as that described above.

A typical mechanical supercharger or an electrically powered supercharger having a similar layout of components to those of the mechanical supercharger further has a constraint that the exhaust pipe and the intake pipe are disposed in accordance with the rotary shaft of the exhaust turbine and the rotary shaft of the intake compressor, which are disposed coaxially with each other. In the supercharging system 10 according to this embodiment, in contrast, the rotary shaft of the exhaust turbine 13 and the rotary shaft of the intake compressor 14 are non-parallel to each other. Thus, the constraint described above can be removed, and the flexibility in the layout of the exhaust pipe and the intake pipe can be improved.

In the embodiment illustrated in FIG. 1, the exhaust turbine 13 is of the axial-flow type. Alternatively, both the exhaust turbine 13 and the intake compressor 14 may be of the centrifugal type, and the rotary shaft of the exhaust turbine 13 and the rotary shaft of the intake compressor 14 may be non-parallel to each other. Even in this configuration, since the two rotary shafts described above are non-parallel to each other, the flexibility in the layout of the exhaust pipe or the intake pipe can be improved for the same reason as that described above.

In the supercharging system 10 according to this embodiment, furthermore, the exhaust turbine 13 is of the axial-flow type, and the intake compressor 14 is of the centrifugal type. The axial-flow exhaust turbine 13 can be operated with higher efficiency than a centrifugal turbine of the same size at a high exhaust flow velocity. The centrifugal intake compressor 14 provides a larger compression ratio than an axial-flow compressor of the same size. Accordingly, a combination of the axial-flow type and the centrifugal type described above allows a large supercharging pressure to be applied to intake air with high energy efficiency, and provides characteristics suitable for a high-rotation and high-output engine.

In the supercharging system 10 according to this embodiment, furthermore, the electric power converter 15 supplies or recovers electric power corresponding to the difference between the operating power of the intake compressor 14 and the electric power generated by the exhaust turbine 13 from or to the electric power storage unit 8 via an electric power path (the electric power line L1) between the exhaust turbine 13 and the intake compressor 14. Accordingly, most of the electric power generated by the exhaust turbine 13 is transmitted to the intake compressor 14 without the intervention of the electric power storage unit 8. Thus, power efficiency of the supercharging system 10 is improved.

An embodiment of the disclosure has been described. However, the disclosure is not limited to the embodiment described above. For example, the embodiment described above presents a method for controlling the electric power converter 15. One or more embodiments of the disclosure may provide any other control method. In the embodiment described above, a portion of electric power can be transmitted directly from the exhaust turbine 13 to the intake compressor 14. Alternatively, the electric power generated by the exhaust turbine 13 may be accumulated in the electric power storage unit 8 and then transmitted to the intake compressor 14. In addition, details presented in the embodiment may be changed as appropriate without departing from the spirit of the disclosure.

1. A supercharging system to be mounted in a vehicle, the vehicle including an engine serving as an internal combustion engine, and a chargeable and dischargeable electric power storage unit, the supercharging system comprising:
an exhaust turbine configured to generate electric power in response to receipt of exhaust from the engine;
an electrically powered intake compressor configured to feed compressed intake air to the engine; and
an electric power converter configured to accumulate the electric power generated by the exhaust turbine in the electric power storage unit and supply the electric power accumulated in the electric power storage unit to the intake compressor, wherein
at least one of the exhaust turbine or the intake compressor is of an axial-flow type.

2. A supercharging system mountable in a vehicle, the vehicle including an engine serving as an internal combustion engine, and a chargeable and dischargeable electric power storage unit, the supercharging system comprising:
an exhaust turbine configured to generate electric power in response to receipt of exhaust from the engine;
an electrically powered intake compressor configured to feed compressed intake air to the engine; and
an electric power converter configured to accumulate the electric power generated by the exhaust turbine in the electric power storage unit and supply the electric power accumulated in the electric power storage unit to the intake compressor, wherein
a rotary shaft of the exhaust turbine and a rotary shaft of the intake compressor are non-parallel to each other.

3. The supercharging system according to claim 2, wherein at least one of the exhaust turbine or the intake compressor is of an axial-flow type.

4. The supercharging system according to claim 1, wherein the exhaust turbine is of the axial-flow type, and the intake compressor is of a centrifugal type.

5. The supercharging system according to claim 3, wherein the exhaust turbine is of the axial-flow type, and the intake compressor is of a centrifugal type.

6. The supercharging system according to claim 1, wherein
the electric power converter is configured to supply or recover electric power corresponding to a difference between operating power of the intake compressor and the electric power generated by the exhaust turbine from or to the electric power storage unit via an electric power path between the exhaust turbine and the intake compressor.

7. The supercharging system according to claim 2, wherein
the electric power converter is configured to supply or recover electric power corresponding to a difference between operating power of the intake compressor and the electric power generated by the exhaust turbine from or to the electric power storage unit via an electric power path between the exhaust turbine and the intake compressor.

8. The supercharging system according to claim 3, wherein
the electric power converter is configured to supply or recover electric power corresponding to a difference between operating power of the intake compressor and the electric power generated by the exhaust turbine from or to the electric power storage unit via an electric power path between the exhaust turbine and the intake compressor.

9. The supercharging system according to claim 4, wherein
the electric power converter is configured to supply or recover electric power corresponding to a difference between operating power of the intake compressor and the electric power generated by the exhaust turbine from or to the electric power storage unit via an electric power path between the exhaust turbine and the intake compressor.

10. The supercharging system according to claim 5, wherein
the electric power converter is configured to supply or recover electric power corresponding to a difference between operating power of the intake compressor and the electric power generated by the exhaust turbine from or to the electric power storage unit via an electric power path between the exhaust turbine and the intake compressor.
